(19) United States
(12) Patent Application Publication
(10) Pub. No.: US 2015/0299490 A1
(43) Pub. Date: Oct. 22, 2015

(54) WRITING INSTRUMENT FOR LABELING FOOD CONTAINERS

(71) Applicant: Mark A. Storch, Marietta, GA (US)

(72) Inventor: Mark A. Storch, Marietta, GA (US)

(73) Assignee: VORTEX CREATIONS, INC., Atlanta, GA (US)

(21) Appl. No.: 14/254,862

(22) Filed: Apr. 16, 2014

(51) Int. Cl. C09D 13/00; B43K 21/08

(52) U.S. Cl. CPC C09D 13/00; B43K 21/08

(57) ABSTRACT

A marking device is disclosed. In at least one embodiment, a marking device having a refillable, washable marking composition for use on food containers, and the like, that is food-safe and non-toxic includes: a housing, elongated and generally cylindrical in form and having a hollow interior channel; a marking composition disposed within the hollow interior channel of the housing, the marking composition consisting of a natural wax; a fatty acid; and a toner; and a marker tip removably coupled to the housing to receive the marking composition within the housing as it is extended outwardly for use.

### FIELD OF THE INVENTION

The technology described herein relates generally to writing and marking instruments. More specifically the technology described herein relates to a writing instrument for labeling food containers. Furthermore, the technology described herein relates to a marking device with a washable marking composition for food containers, and the like, that is food-safe and non-toxic, and wherein the marking composition is refillable.

### BACKGROUND OF THE INVENTION

Writing and marking instruments are devices to enable one to write or mark a particular surface. Certain surfaces are problematic for receipt of certain marking compositions, and such surfaces are not easily marked as a result. Others have attempted to overcome these deficiencies with improved writing and marking instruments; however, these devices have been found also to have various shortcomings.

Related utility patent application publications known in the art include the following:

U.S. Patent Application Publication No. 2010/0221440, filed by Patel et al. and published on Sep. 2, 2010, discloses a food-grade marking composition useful for marking and labeling surfaces of food processing equipment includes a food grade base polymer, a coloring agent, and a volatile organic solvent. A marker pen is also provided which includes the food grade marking composition in combination with a delivery instrument. The food grade base polymer meets the regulatory requirements of 21 C.F.R. section 175.300 for incidental food contact applications.

Related non-patent literature known in the art includes the following:

http://www.amazon.com/Jokari-47826-Erasable-Labels-Markers/dp/B002MPH4OG, available online Mar. 11, 2014, discloses erasable food container labels. These erasable food container labels, which are permanent in nature, are erasable when combined with use on these specialized labels.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a refillable marking device with a washable marking composition for food containers, and the like, that is food-safe and non-toxic.

In one exemplary embodiment, the technology described herein provides a marking device having a refillable, washable marking composition for use on food containers, and the like, that is food-safe and non-toxic. The marking device includes: a housing, elongated and generally cylindrical in form and having a hollow interior channel; a marking composition disposed within the hollow interior channel of the housing, the marking composition consisting of a natural wax; a fatty acid; and a toner; and a marker tip removably coupled to the housing to receive the marking composition within the housing as it is extended outwardly for use.

In at least one embodiment of the marking device, the marking device also includes a twist cap coupled to the housing, to be twisted to advance the marking composition disposed within the hollow interior channel of the housing to extend into the marker tip and extended outwardly for use.

In at least one embodiment of the marking device, the marking device further includes a driving column disposed within the hollow interior channel of the housing twisted to advance the marking composition disposed within the hollow interior channel of the housing to extend into the marker tip and extended outwardly for use.

In at least one embodiment of the marking device, the marking device also includes an aperture disposed within a distal end of the marker tip to guide the marking composition as it advances within the hollow interior channel of the housing to extend into the marker tip and extends outwardly for use.

In at least one embodiment of the marking device, the natural wax includes a beeswax.

In at least one embodiment of the marking device, the fatty acid includes stearic acid.

In at least one embodiment of the marking device, the fatty acid includes zinc stearate, a zinc salt of stearic acid.

In at least one embodiment of the marking device, the fatty acid includes stearic acid and zinc stearate, a zinc salt of stearic acid.

In at least one embodiment of the marking device, the toner includes a titanium toner.

In at least one embodiment of the marking device, the marking composition disposed within the hollow interior channel of the housing includes a refillable insert.

In at least one embodiment of the marking device, the marking composition disposed within the hollow interior channel of the housing comprises a generally cylindrical solid form.

In another exemplary embodiment a marking composition for use on food containers, and the like, that is food-safe and non-toxic is provided. The marking composition includes: a natural wax base; a fatty acid; and a toner.

In at least one embodiment of the marking composition, the natural wax includes a beeswax.

In at least one embodiment of the marking composition, the fatty acid includes stearic acid.

In at least one embodiment of the marking composition, the fatty acid includes zinc stearate, a zinc salt of stearic acid.

In at least one embodiment of the marking composition, the fatty acid includes stearic acid and zinc stearate, a zinc salt of stearic acid.

In at least one embodiment of the marking composition, the toner includes a titanium toner.

In at least one embodiment of the marking composition, the marking composition includes a refillable insert for use in a pen-like device.

In at least one embodiment of the marking composition, the marking composition comprises a generally cylindrical solid form.

In another exemplary embodiment a method for marking food containers, and the like, that is food-safe and non-toxic is provided. The method includes: providing a marking device having a refillable, washable marking composition, the marking device including: a housing, elongated and generally cylindrical in form and having a hollow interior channel; a marking composition disposed within the hollow interior channel of the housing, the marking composition consisting of a natural wax; a fatty acid; and a toner; and a marker tip removably coupled to the housing to receive the marking composition within the housing as it is extended outwardly for use; a twist cap coupled to the housing, to be twisted to advance the marking composition disposed within the hollow interior channel of the housing to extend into the marker tip and extended outwardly for use; and a driving column disposed within the hollow interior channel of the housing twisted to advance the marking composition disposed within the hollow interior channel of the housing to extend into the marker tip and extended outwardly for use; advancing the marking composition with the hollow interior channel of the housing, extending into the marker tip, and extending outwardly for use; applying the marker tip to a surface to be marked with sufficient pressure to apply the marking composition to the surface and to leave a marking; and moving the marker tip along the surface to write on the surface, leaving a mark of the marking composition.

Advantageously, the technology described herein provides a marking instrument that eliminates the need for expensive labels. Such labels are designed for single use and are hard to remove. This technology provides an easy to use, inexpensive alternative to such labels.

Also advantageously, the technology described herein provides a marking instrument that can write on non-porous surfaces. By way of example, the marking instrument can be used on food pans, stainless steel, and reservation boards.

Further advantageously, the technology described herein provides a marking instrument that is food-safe and non-toxic. The marking instrument creates a mark on a surface that is easily cleaned with soap and water.

Further advantageously, the technology described herein provides a marking instrument that is beneficial in commercial and institutional settings. By way of example, this marking device will be useful to restaurants, schools, kitchen facilities, and so forth. Use of such a marking device allows these institutions to avoid use of labels which provides great cost savings. The marking device requires less training of the prep staff, requires less work, and provides for quick labeling of items. The marking device reduces errors, therefore decreasing risk and liability. The marking device endures compliance with FDA Food Code and HACCP food management systems. Additionally, the marking device reduces food waste due to improper sticky labeling.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective view of a writing instrument for labeling food containers, illustrating, in particular, a housing assembly containing a novel food-grade, non-toxic marking composition, according to an embodiment of the technology described herein;

FIG. 2 is an expanded view of the writing instrument for labeling food containers, depicted in FIG. 1, illustrating, in particular, the components of the writing instrument shown in expanded, unassembled form, according to an embodiment of the technology described herein;

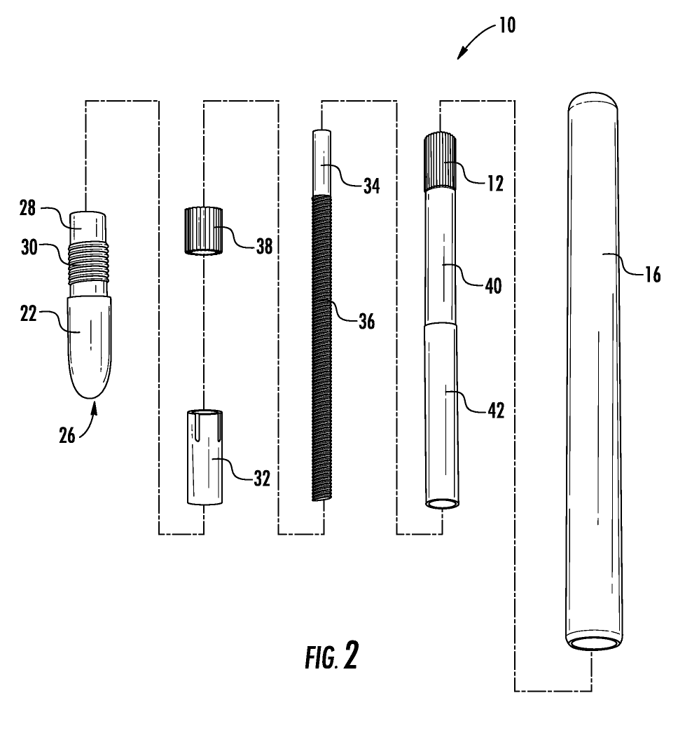

FIG. 3 is a side view of the writing instrument for labeling food containers, depicted in FIG. 1, illustrating, in particular, the profile of the instrument, the clip, the twisting tip, and the marking composition in a recessed state within the housing, according to an embodiment of the technology described herein; and

FIG. 4 is a perspective view the writing instrument for labeling food containers, depicted in FIG. 1, illustrating, in particular, the writing instrument in use shown marking a food container with the tip of the marking composition from within the writing instrument, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

Writing on plastic and like surfaced food containers is usually done with a Sharpie® type marker which is permanent. This defeats the reusability of containers for other items. Other markers, such as for example, grease pencils, crayons, and paint pens do not work well either. Additionally all of these marking instruments are no food-safe and non-toxic. In each case these marking instruments either ruin the container and/or do not work well. Utilizing stickers or labels on containers and then writing on the stickers is one option, but such use results in sticky label residue and time consuming cleaning efforts for reuse of the container. There are many deficiencies and shortcomings with these marking instruments.

In various exemplary embodiments, the technology described herein provides a refillable marking device with a washable marking composition for food containers, and the like, that is food-safe and non-toxic.

The marking device is suitable for labeling, for example, food leftovers in a container. The device is suitable on plastic surfaces and also on surfaces such as reservation boards and the like.

The marking device is in a form of a stick for use like a refill in a pen-like device. The composition used within the marking device is food-safe and non-toxic.

Once used the marking composition is easily removed from a surface. With soap and water the markings can easily be removed.

Additionally, the marking composition does not smear and is not compromised by heat and condensation. Testing of the marking composition has found that heat and condensation do not adversely affect the applied markings. This is very beneficial for containers having food items where any loss of the labeling information would likely result in the loss of food at an expense to the owner.

In use, the marking device allows for repeatedly writing on food containers for labelling and identification purposes, and provides for ease of use to reuse the containers. There is a significant savings in both time and money when using this marking device instead of using traditional sticky labels and markers. This marking instrument eliminates the need for expensive labels. Such labels are designed for single use and are hard to remove. This technology provides an easy to use, inexpensive alternative to such labels.

In addition to food containers, the marking device also is suitable for clothing containers, restaurant equipment, stainless steel, glass, plastic, laminate, metal, holding bins and pans, reservation boards, and so forth. Testing has shown that the marking device applies very well to Pyrex®, Rubbermaid®, Tupperware®, and other brand name container and pan devices ubiquitous in the marketplace. The marking instrument can write on dry, non-porous surfaces.

Due to the nature of the marking composition used, the marking device does not dry out. Known marking device systems dry out over time. Thus, this marking device provides a device that is much longer lasting.

The marking instrument is beneficial in commercial and institutional settings. By way of example, this marking device will be useful to restaurants, schools, kitchen facilities, and so forth. Use of such a marking device allows these institutions to avoid use of labels which provides great cost savings. The marking device requires less training of the prep staff, requires less work, and provides for quick labeling of items. The marking device reduces errors, therefore decreasing risk and liability. The marking device endures compliance with FDA Food Code and HACCP food management systems. This product conforms to U.S. Consumer Product Safety Improvement Act, and is therefore exempt from the OSHA Hazard Communication Standard as an Article. Additionally, the marking device reduces food waste due to improper sticky labeling.

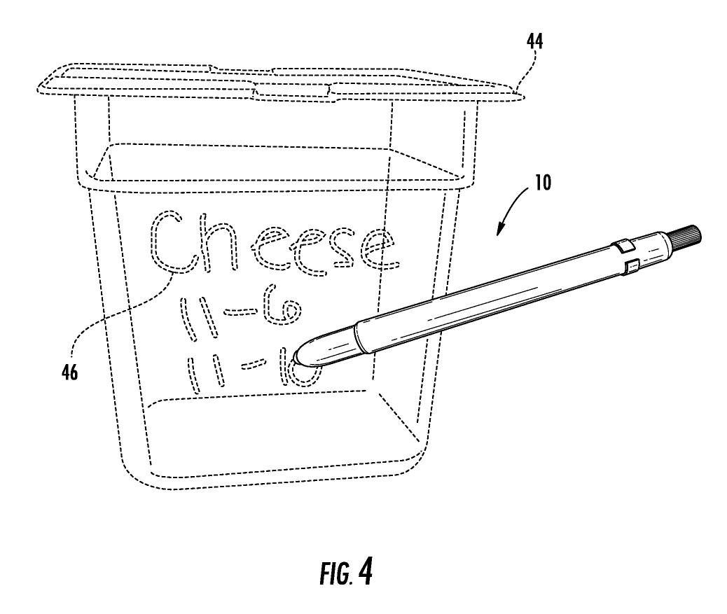

Referring now to the figures, a writing instrument 10 marking device having a refillable, washable marking composition for labeling food containers, and the like, such as for example, container 44 in FIG. 4, that is food-safe and non-toxic, is shown. The marking device includes a housing 16. The housing 16 is essentially shell within which or coupled to all other elements work. The housing 16 is elongated and generally cylindrical in form and having a hollow interior channel.

In at least one embodiment, the writing instrument 10 includes a clip 18. Clip 18 provides a means by which the writing instrument 10 can be attached to an item, such as for example, a pocket in a shirt. The clip 18 is plastic in at least one embodiment. The clip 18 is metal in at least one embodiment. The clip 18 includes cuff 14 by which the clip is attached to the housing 16 of the writing instrument 10.

The marking device includes a marking composition 24. The marking composition 24 is disposed within the hollow interior channel of the housing 16. The marking composition 24 is food-safe and non-toxic. The marking composition 24 provides a means by which a container 44 can be marked with a mark 46, as depicted in FIG. 4, to identify an item contained within the container 44.

The marking device includes a marker tip 22. The marker tip 22 is removably coupled to the housing 16 to receive the marking composition 24 within the housing 16 as it is extended outwardly for use. In at least one embodiment, the point at which the marker tip 22 and the housing 16 are coupled is contoured with taper 20.

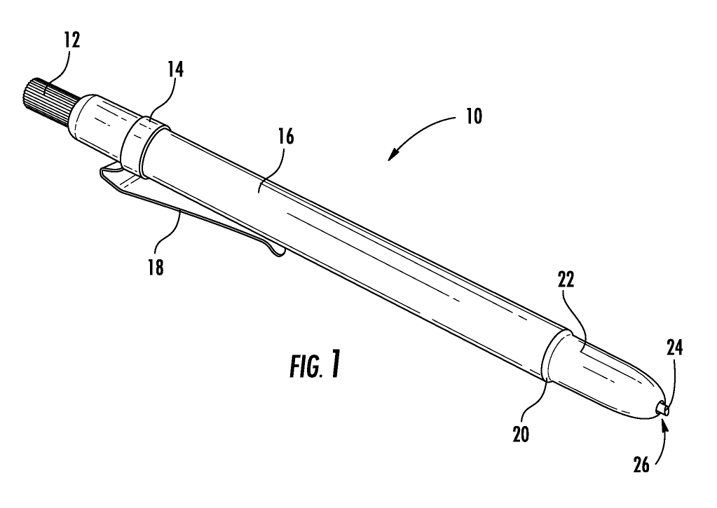

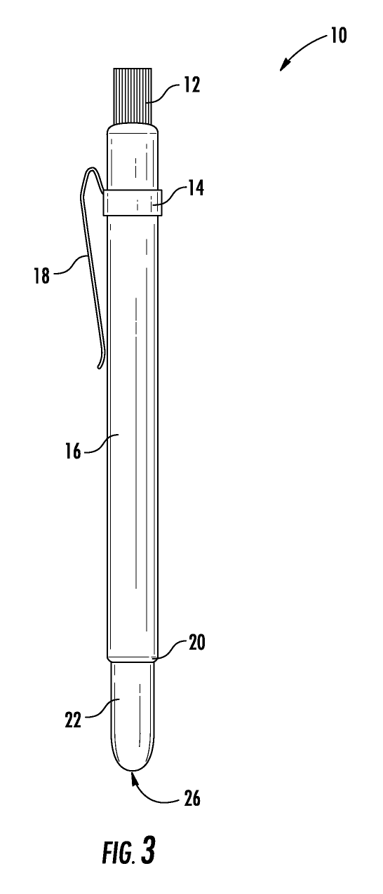

The marker tip 22 includes an aperture 26. The aperture 26 is disposed within a distal end of the marker tip 22 to guide the marking composition 24 as it advances within the hollow interior channel of the housing 16 to extend into the marker tip 22 and extends outwardly for use. As depicted in FIG. 1, the marking composition 24 is extended out from the aperture 26. As depicted in FIG. 3, the marking composition 24 is not extended out from the aperture 26 and is in a retracted or non-extended form.

The marker tip 22 includes threads 30. The threads 30 are configured to be received by the hollow interior channel of the housing 16. As such, the marker tip 22 is removable by the user in order to replace the marking composition 24 when the prior one is used. The threads 30 are disposed on the marker tip 22 at surface 28, which is slightly less in diameter than the remaining portion of the marker tip 22 to allow room for the threads 30 within the housing 16.

The marking device 10 includes a twist cap 12. The twist cap 12 is coupled to the housing 16. As twisted the twist cap 12 advances the marking composition 24 disposed within the hollow interior channel of the housing 16 to extend into the marker tip 22 and extended outwardly for use.

The twist cap 12 can be a portion of a large cylindrical sleeve have a first portion 40 and a second portion 42. The sleeve is sized such that it fits within the hollow interior channel of the housing 16. The sleeve also covers the driving column 34.

The marking device 10 includes a driving column 34. The driving column 34 is disposed within the hollow interior channel of the housing 16. The driving column 34 includes threads 36 in at least one embodiment. The driving column 34 is configured to advance the marking composition 24 disposed within the hollow interior channel of the housing 16 to extend into the marker tip and extended outwardly for use. Placement spacers such as 38 and 32 are utilized within the housing 16 to further couple and secure the driving column 34, marker tip 22 within the housing 16.

The marking device 10 can vary in size and shape. However, in at least one embodiment, the marking device 10 is approximately five and a quarter inches in length and approximately three eights of an inch in width. The marker tip 22 of the device 10 is approximately one fourth of an inch in width. The lengths, widths, diameters of the marking device 10 can vary based on use and application.

In at least one embodiment, the marking composition 24 includes a natural wax, a fatty acid, and a toner. Additionally, in varied embodiments, the marking composition 24 also includes ceresin. Furthermore, in varied embodiments, the marking composition 24, also includes talc powder. Still furthermore, in varied embodiments, the marking composition includes beef tallow. These novel combinations and compositions provides a marking means that is easily washable and well suited for marking food storage containers and the like. The marking composition 24 can include varied coloring agents to vary the color of the markings.

A natural wax is an organic compound. It is plastic (malleable) near ambient temperatures. Because of its properties, a natural wax is useful as a base for the marking composition. In at least one embodiment, the natural wax is a beeswax. Beeswax is a natural wax produced in the bee hive of honey bees of the genus Apis. It is mainly esters of fatty acids and various long-chain alcohols. Small amounts of beeswax have food and flavoring applications, and are edible in the sense of having similar toxicity to undigestable plant waxes. However, the wax monoesters in beeswax are poorly hydrolysed in the guts of humans and mammals, so are of no significant food value. With the base of beeswax, other composition elements are added that are suitable for a marking composition 24 in the marking device 10. In at least one embodiment, the marking composition includes 8-12% beeswax. In at least one embodiment, the marking composition 24 comprises 10% beeswax.

Ceresin is a wax derived from ozokerite by a purifying process. The purifying process of the ozokerite commonly comprises a treatment with heat and sulfuric acid, but other processes are also in use. Ceresin can be used as an alternative to, or in combination with beeswax. In at least one embodiment, the marking composition 24 includes between 8-12% ceresin. In at least one embodiment, the marking composition 24 comprises 10% ceresin.

Beef tallow is a rendered form of beef, processed from suet. It is solid at room temperature. Unlike suet, tallow can be stored for extended periods without the need for refrigeration to prevent decomposition, provided it is kept in an airtight container to prevent oxidation. In industry, tallow is not strictly defined as beef or mutton fat. In this context, tallow is animal fat that conforms to certain technical criteria, including its melting point. It is common for commercial tallow to contain fat derived from other animals, such as lard from pigs, or even from plant sources. In at least one embodiment, the marking composition 24 includes between 8-12% beef tallow. In at least one embodiment, the marking composition 24 comprises 10% beef tallow.

Talc is a mineral composed of hydrated magnesium silicate with the chemical formula H₂Mg₃(SiO₃)₄ or Mg₃Si₄O₁₀(OH)₂. In loose form, it is the widely used substance known as talcum powder. It occurs as foliated to fibrous masses, and in an exceptionally rare crystal form. It is the softest known mineral and listed as I on the Mohs hardness scale. It can be easily scratched by a fingernail. In at least one embodiment, the marking composition 24 includes between 4-6% talc powder. In at least one embodiment, the marking composition 24 comprises 5% talc powder.

A fatty acid is a carboxylic acid (organic compound) with a long aliphatic tail (chain), which is either saturated or unsaturated. Most naturally occurring fatty acids have a chain of an even number of carbon atoms, from 4 to 28. Fatty acids are usually derived from triglycerides or phospholipids. When they are not attached to other molecules, they are known as “free” fatty acids. Stearic acid and zinc stearate are fatty acids. In at least one embodiment, the marking composition 24 includes between 40-50% stearic acid. In at least one embodiment, the marking composition 24 comprises 45% stearic acid.

The commercial stearic acid from which the stearate salts are manufactured is actually a mixture of monocarboxylic acids obtained from animal and/or vegetable sources. In general, applications of stearic acid exploit its bifunctional character, with a polar head group that can be attached to metal cations and a nonpolar chain that confers solubility in organic solvents. The combination leads to uses as a surfactant and softening agent. Stearic acid undergoes the typical reactions of saturated carboxylic acids. The salts and esters of stearic acid are called stearates. Stearic acid is one of the most common saturated fatty acids found in nature. One such stearate is zinc stearate.

The Stearate salts, including Lithium Stearate, Aluminum Distearate, Aluminum Stearate, Aluminum Tristearate, Ammonium Stearate, Calcium Stearate, Magnesium Stearate, Potassium Stearate, Sodium Stearate, and Zinc Stearate are fine, white powders with a slight fatty odor. In cosmetics and personal care products, Stearate salts are used mainly in the formulation of makeup products such as eyeliner, eye shadow, mascara, lipsticks, blushers, face powders and foundations. They are also used in fragrances, deodorants, and hair and skin care products. The Stearate salts are generally used for their lubricating properties. They also help to keep emulsions from separating into their oil and liquid components. The Stearate salts increase the thickness of the lipid (oil) portion of cosmetics and personal care products and reduce the clear or transparent appearance of finished products.

With this combined marking composition 24 of beeswax, serving as a base, stearic acid, as a softening agent, and zinc stearate, as a lubricant, a useful means for marking containers for food and the like is made. Additionally, a toner is utilized within the marking composition 24. The toner can be used to provide color to the marking composition 24. It at least one embodiment, the toner is titanium. Alternative toners are anticipated in various embodiments. In at least one embodiment, titanium dioxide is used between 15 to 25% of the marking composition 24. In at least one embodiment, titanium dioxide comprises 20% of the marking composition 24.

Therefore, it at least one preferred embodiment, the marking composition comprises: 40-50% stearic acid, 15-25% titanium dioxide, 8-12% beeswax, 8-12% beef tallow, 8-12% ceresin, and 4-6% talc powder.

In yet another preferred embodiment, the marking composition comprises: 45% stearic acid, 20% titanium dioxide, 10% beeswax, 10% beef tallow, 10% ceresin, and 5% talc powder.

The marking device 10 can be utilized with the following method steps: providing a marking device having a refillable, washable marking composition 24; advancing the marking composition with the hollow interior channel of the housing 16, extending into the marker tip 22, and extending outwardly for use; applying the marker tip 22 to a surface 44 to be marked with sufficient pressure to apply the marking composition to the surface and to leave a marking 46; and moving the marker tip 22 along the surface 44 to write on the surface, leaving a mark 46 of the marking composition 24. Additionally, the method can include refilling the marking composition 24 when a new one is needed.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A marking device having a refillable, washable marking composition for use on food containers, and the like, that is food-safe and non-toxic, the marking device comprising:
a housing, elongated and generally cylindrical in form and having a hollow interior channel;
a marking composition disposed within the hollow interior channel of the housing, the marking composition consisting of a natural wax; a fatty acid; and a toner; and
a marker tip removably coupled to the housing to receive the marking composition within the housing as it is extended outwardly for use.

2. The marking device of claim 1, further comprising:
a twist cap coupled to the housing, to be twisted to advance the marking composition disposed within the hollow interior channel of the housing to extend into the marker tip and extended outwardly for use.

3. The marking device of claim 1, further comprising:
a driving column disposed within the hollow interior channel of the housing twisted to advance the marking composition disposed within the hollow interior channel of the housing to extend into the marker tip and extended outwardly for use.

4. The marking device of claim 1, further comprising:
an aperture disposed within a distal end of the marker tip to guide the marking composition as it advances within the hollow interior channel of the housing to extend into the marker tip and extends outwardly for use.

5. The marking device of claim 1, wherein the natural wax comprises a beeswax.

6. The marking device of claim 1, wherein the fatty acid comprises stearic acid.

7. The marking device of claim 1, wherein the fatty acid comprises zinc stearate, a zinc salt of stearic acid.

8. The marking device of claim 1, wherein the fatty acid comprises stearic acid and zinc stearate, a zinc salt of stearic acid.

9. The marking device of claim 1, wherein the toner comprises a titanium toner.

10. The marking device of claim 1, wherein the marking composition disposed within the hollow interior channel of the housing comprises a refillable insert.

11. The marking device of claim 1, wherein the marking composition disposed within the hollow interior channel of the housing comprises a generally cylindrical solid form.

12. A marking composition for use on food containers, and the like, that is food-safe and non-toxic, the marking composition comprising:
a natural wax base;
a fatty acid; and
a toner.

13. The marking composition of claim 13, wherein the natural wax comprises a beeswax.

14. The marking composition of claim 13, wherein the fatty acid comprises stearic acid.

15. The marking composition of claim 13, wherein the fatty acid comprises zinc stearate, a zinc salt of stearic acid.

16. The marking composition of claim 13, wherein the fatty acid comprises stearic acid and zinc stearate, a zinc salt of stearic acid.

17. The marking composition of claim 13, wherein the toner comprises a titanium toner.

18. The marking composition of claim 13, wherein the marking composition comprises a refillable insert for use in a pen-like device.

19. The marking composition of claim 13, wherein the marking composition comprises a generally cylindrical solid form.

20. A method for marking food containers, and the like, that is food-safe and non-toxic, the method comprising:
providing a marking device having a refillable, washable marking composition, the marking device comprising:
a housing, elongated and generally cylindrical in form and having a hollow interior channel;
a marking composition disposed within the hollow interior channel of the housing, the marking composition consisting of a natural wax; a fatty acid; and a toner; and
a marker tip removably coupled to the housing to receive the marking composition within the housing as it is extended outwardly for use;
a twist cap coupled to the housing, to be twisted to advance the marking composition disposed within the hollow interior channel of the housing to extend into the marker tip and extended outwardly for use; and
a driving column disposed within the hollow interior channel of the housing twisted to advance the marking composition disposed within the hollow interior channel of the housing to extend into the marker tip and extended outwardly for use;
advancing the marking composition with the hollow interior channel of the housing, extending into the marker tip, and extending outwardly for use;
applying the marker tip to a surface to be marked with sufficient pressure to apply the marking composition to the surface and to leave a marking; and
moving the marker tip along the surface to write on the surface, leaving a mark of the marking composition.
